(19) United States
(12) Patent Application Publication
(10) Pub. No.: US 2004/0094526 A1
(43) Pub. Date: May 20, 2004

(54) Cutting laser beam nozzle assembly

(76) Inventor: Edward D. McCoy, San Clemente, CA (US)

Correspondence Address: Allen D. Brufsky, Ferrell Schultz Carter Zumpano & Fertel, P.A., Suite 3400, 201 South Biscayne Blvd., Miami, FL, 33131, US

(21) Appl. No.: 10/298,184

(22) Filed: Nov. 15, 2002

(51) Int. Cl. B23K 26/14

(52) U.S. Cl. 219/121.84; 219/121.75; 219/121.67

(57) ABSTRACT

The present invention provides an improved nozzle assembly for deriving the final focus of a laser beam for a fine precision cut. A dial is integrally coupled to a nozzle body and a focusing lens group housing. The dial can be rotated in a clockwise or counterclockwise direction along its own axis. As the dial is being rotated, the dial's rotary motion engages the focusing lens group housing to also rotate on its own axis, and the focusing lens group contained within the housing can therefore be appreciably raised or lowered, significantly aiding the final focus. The dial has units of measurement that can be used to track the rotational position of the final focus. Similarly, the height indicator contains a micrometer that registers the final focus such that it can be recorded and replicated.

### BACKGROUND OF THE INVENTION

1. Field of the Invention

This invention relates to a cutting laser beam nozzle assembly. Specifically, this invention relates to a laser beam nozzle assembly for adjusting the final focus of a laser beam relative to the height of the outer surface of a workpiece providing a greater degree of precision in the cutting of the workpiece.

2. Description of the Prior Art

In laser beam cutting, the laser beam is directed to the workpiece through a nozzle assembly. Generally, there is a set distance between the focusing lens group and the outer surface of the workpiece at which point final focusing occurs and the cutting can begin. The degree of precision of the cut is directly related to the final focus of the laser beam and the physical and chemical composition of the workpiece.

Most automated, computer-driven laser cutting apparatus for effecting a cut on a small workpiece have three degrees of movement, namely an X-axis for linear movement of the workpiece relative to the beam, a Y-axis (rotary axis) to effect rotation of the workpiece relative to the beam around the X-axis, and a Z-axis or height adjustment of the laser beam focusing mechanism. The downward height adjustment of the laser beam focusing mechanism is generally restricted to a certain focal distance between the nozzle tip and the outer surface of the workpiece. However, in certain applications, particularly those involving the cutting of thin small parts or workpieces, greater precision and flexibility is desired. In those instances, it may be necessary to reduce the final focus to closer approach the outer surface of the workpiece.

Final focus is generally attained by manipulating the focusing lens group that is contained within the focusing lens group housing relative to the outer surface of the workpiece. As is well known in the pertinent art, the focusing lens group can be used to control the width of the beam thereby controlling the beam's intensity, while the focusing lens group housing generally controls the depth of the final focus by the raising and/or lowering of the housing relative to the height of the workpiece.

Typical laser cutting methods and apparatuses are shown in U.S. Pat. Nos. 6,426,479; 6,417,487, 6,407,360; 6,369,355; 5,345,057 and 6,114,653.

These manufacturing methods and apparatuses have various limitations and do not provide a method or apparatus for further refining the final focus of a laser beam when cutting workpieces of varied diameter. This is especially true for thin walled materials of the type most often used to form stents. Accordingly, many stents are rejected as failing to meet the necessary cut accuracy when manufactured by the methods and apparatuses used prior to this invention. Thus a greater degree of focus is desired with the ability to adjust the laser beam focusing mechanism in a manner to obtain a better cut.

### SUMMARY OF THE INVENTION

The present invention provides for an improved nozzle assembly for adjusting a final focus of a laser beam relative to a nozzle tip to produce a precision cut.

An objective of the present invention is to provide improved means for laser beam cutting at a point relative to the nozzle tip such that the final focus can be varied according to the height of the workpiece.

Another objective of the present invention is to provide a nozzle assembly capable of changing the focus during a cutting operation to have a sufficiently reduced final focus without moving the nozzle.

Another objective of the present invention is to provide means for the simultaneous movement of the laser focusing mechanism in conjunction with the nozzle body relative to the workpiece to reduce the final focus for the cutting of a workpiece.

The achievement of these objectives are accomplished by providing a novel dial which is incorporated in the apparatus of the invention that is integrally coupled to a nozzle body and a focusing lens group housing. The dial extends circumferentially around the nozzle body and the focusing lens group housing and may be rotated in a clockwise or counterclockwise direction along a Y (rotary) axis. As the dial rotates, the dial's rotary motion engages the focusing lens group housing to simultaneously rotate along a Y-axis, and the focusing lens group contained within the housing can be appreciably raised or lowered as desired according to the height of the workpiece. Thus, the focusing lens group may be adjusted relative to the nozzle tip to approach the outer surface of the workpiece without moving the nozzle. As the focusing lens group approaches the nozzle tip, a corresponding significant reduction in the final focus occurs.

Another objective of the invention is to provide means for recording measurements of the final focus. In certain instances, for example experimental use, it may be desirable to have a mechanism for measuring and recording the final focus for future reference such that the measurements may be applied to similar materials.

The proposed invention discloses an improved system for measuring and recording the rotational position of the focusing lens group relative to the nozzle tip where it is measurable on both a dial for the minor measurement, and a height indicator for the major measurement by a micrometer. The dial's exterior cylindrical surface is marked off in units for measuring the rotational position of the dial. When the dial is rotated along the Y-axis, the dial's movement causes an internal pin of the height indicator, that is proximally placed adjacent to the dial, to move along a Z-axis (vertical axis) such that the final focus registers on the height indicator's micrometer. Therefore, the final rotational position can be noted from both the height indicator's micrometer measurements and the demarcations on the dial.

### BRIEF DESCRIPTION OF THE DRAWINGS

Further objectives and advantages of the invention will become more apparent from the following description and claims, and from the accompanying drawings, wherein:

FIG. 1 is a perspective view of the nozzle assembly.

FIG. 2 is a longitudinal cross-sectional view of the laser beam nozzle assembly of FIG. 1 taken substantially along the plane indicated by line 2-2 of FIG. 1; and

FIG. 3 is a longitudinal cross-sectional view of the laser beam nozzle assembly of FIG. 2 rotated 90°.

### DETAILED DESCRIPTION OF THE PREFERRED EMBODIMENT

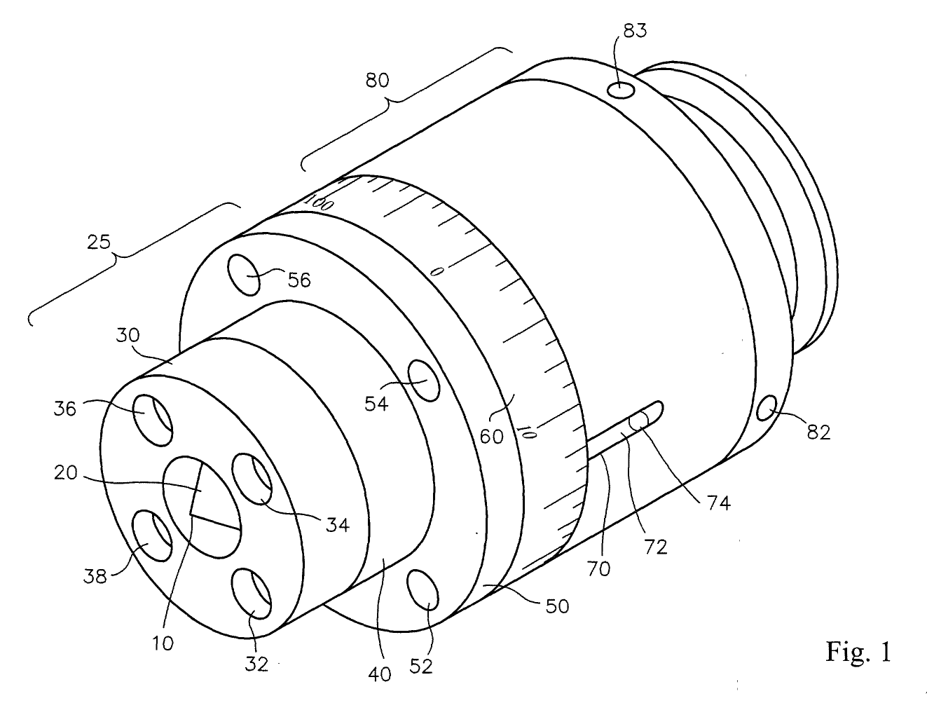

Referring now to the drawings in detail, wherein like numerals indicate like elements throughout the several views, there is shown in FIG. 1 the nozzle assembly 10 in accordance with the invention.

The nozzle assembly 10 includes a nozzle 20 supported in position by a nozzle body 25, a dial 60 with a height indicator 70, and a focusing lens group housing 80. The nozzle 20 has a conically shaped inner opening that tapers at the nozzle tip 11 for a laser beam to be irradiated through the nozzle tip 11 to the workpiece being cut. The nozzle 20 is enclosed within the nozzle body 25 which includes a nozzle lens retainer 30, gas delivery chamber 40, and a nozzle support 50.

The nozzle lens retainer 30 has an inner annular opening for centering and retaining the nozzle 20, with exterior holes 32, 34, 36, 38 in the outer circumference for the securing of the nozzle 20 within the nozzle body 25. In one embodiment, the securing means may be accomplished with bolts, screws or union nuts, or other similar securing means, being bolted to the gas delivery chamber 40. The gas delivery chamber 40 is cylindrical in shape and provides for the introduction of a gas stream that substantially surrounds the focused beam along the laser beam's axis in a manner more fully described in conjunction with FIG. 3. The gas delivery chamber 40 has a continuous mounting flange for attachment to the dial 60 where it is affixed by the nozzle support 50. The nozzle support 50 comprises of an open cylinder with an inner radius larger than the nozzle lens retainer 20 and the gas delivery chamber 40 to facilitate embracing both the nozzle lens retainer 20 and the gas delivery chamber 40. Depending on the implementation, the nozzle support 50 may be secured to the dial 60 by one or more screws, bolts, or union nuts threaded through the screw holes 50, 52, 54.

A cylindrical dial 60 is incorporated in the apparatus of the invention which provides means for the focusing lens group housing 80 to be rotated about its own axis further reducing the final focus. The dial 60 may be rotated in a clockwise or counterclockwise direction along the Y-axis to achieve greater depth for the final focus. Movement of the dial 60 is measurable pursuant to the demarcations on the dial's 60 exterior cylindrical surface representing a minor rotational position measured in millimeters. A height indicator 70 is proximally placed adjacent to the dial 60, where the height indicator 70 tracks the major rotational position of the final focus by movement of an external knob 74 that slides in a groove 72 along the Z-axis as measured by the micrometer for the height indicator 70. Therefore, measurements for the final focus can be recorded and replicated for similar materials.

Integrally coupled to the dial 60 is the focusing lens group housing 80 encasing an aperture which is continuous throughout the housing 80 and the nozzle body 25, tapering at the nozzle tip 11 for the delivery of a precisely dimensioned laser beam to the workpiece being cut.

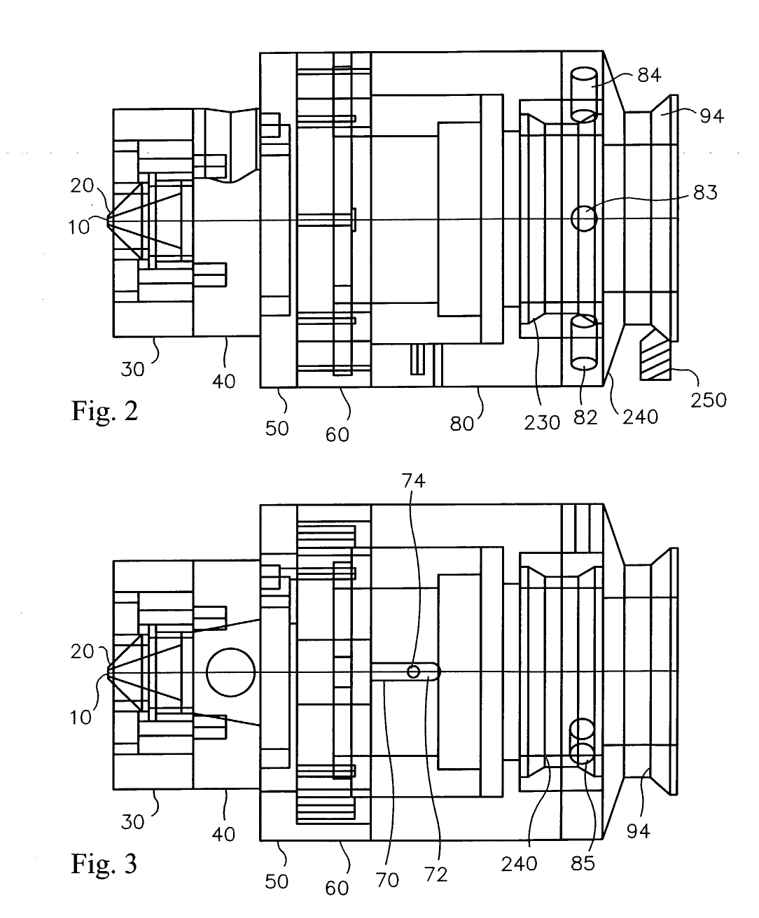

The focusing of a laser beam and deriving of a final focus will be more fully described in conjunction with FIG. 2.

FIG. 2 is a longitudinal cross-sectional view of the laser beam nozzle assembly 10 of FIG. 1 illustrating in further detail the laser focusing mechanism.

The laser focusing mechanism includes the focusing lens group housing 80 and the focusing lens group 230 contained within. The focusing lens group 230 is movably retained in position by a housing support 240 with screw holes 82, 83, 84, that provide for the alignment of the focusing lens group 230 within the focusing lens group housing 80. Further, the housing support 240 has a continuous mounting flange 94 for engagement with an inner diameter of a laser head (not shown). The mounting flange 94 provides for connection to the laser head (not shown) by means of retaining screws 250 which press against the outer surface of the mounting flange 94, thereby positioning and restraining the nozzle assembly 10 to the laser head (not shown).

The focusing lens group 230 can be used to control the width of the beam thereby controlling the beam's intensity, while the focusing lens group housing 80 generally controls the depth of the final focus by the raising and/or lowering of the housing 80 relative to the height of the outer surface of a workpiece.

Typically, the focusing of a laser beam requires that a laser beam is first directed through the aperture which runs continuously throughout the focusing lens group housing 80 and the nozzle body 25 until it tapers at the nozzle tip 11. The laser focusing mechanism can be further adjusted to tailor the beam for a final focus relative to the size of the workpiece, as reflected by the height of the workpiece's outer surface. Final focus prior to cutting generally occurs at a set focal distance from the nozzle tip 11 relative to the outer surface of the workpiece usually within a few millimeters from each other. Final focus is also representative of the focal distance between the focusing lens group 230 relative to the nozzle tip 11.

Unlike the prior art, further refining of the final focus can be achieved by rotating the dial 60 in a circular motion along a Y-axis. In one embodiment, the dial 60 may be rotated to a predetermined focal distance as measured by the demarcations on the dial 60 and/or the height indicator 70. In another embodiment, the final focus may be derived by rotating the dial 60 until an operator of the laser machine is satisfied that the final focus will accomplish the desired precision kerf for the workpiece being cut. In both embodiments, the precise location of the final focus as registered by the dial 60 and/or the height indicator 70 can be noted for future reference and use.

The final focus of the laser beam determines the depth and precision of the cut. The smaller the diameter of the workpiece, the greater precision required for a fine kerf. Further reduction of the final focus provides for increased flexibility in cutting, since the final focus relative to the nozzle tip 11 can be varied according to the height of the workpiece and a precision cut is ensured irrespective of the workpiece's diameter.

The final focus is determined by the concurrent movement of the dial 60 and the focusing lens group housing 80 in conjunction with the nozzle body 25. The dial 60 is interconnected to the distal end of the focusing lens group 230 by an axle 286 centered in a hub 284 of a wheel 288 such that when the dial 60 is rotated, the axle 286 also rotates on a rotary axis. The outer circumference of the wheel 288 is connected to the inner wall of the dial's 60 cylinder by a pair of pins 270, 272 on the focusing lens group housing 80 jutting outwardly riding in the contiguous grooves 280, 282 of the dial's 60 spiral track 260 which has very light threading as indicated by the dotted lines in FIG. 2.

When the dial 60 is rotated, the pins 270, 272 are engaged into the dial's 60 spiral grooves 280, 282 moving the focusing lens group 230 either upwards or downwards incrementally along a Z-axis according to the rotating direction of the dial 60. Therefore, the focusing lens group 230 can be appreciably lowered or raised towards the nozzle tip 11 and can be adjusted to move closer to the outer surface of a workpiece. Correspondingly, the final focus relative to the outer surface of the workpiece is thereby reduced.

FIG. 3 is a longitudinal cross-sectional view of the laser beam nozzle assembly 10 of FIG. 2 rotated 90° illustrating in greater detail, the height indicator 70 and the gas delivery chamber 40. In the preferred embodiment, the height indicator 70 comprises of a knob 74 assembled in a groove 72, where the knob 74 moves in conjunction with the rotation of the dial 60 along a Z-axis to capture the final focus of the focusing lens group 230. As the dial 60 is rotated along its own axis, the dial engages a pin (not shown) that is connected to the external knob 74 such that as the dial 60 moves, the internal pin connected to the external knob 74 moves in conjunction with the dial 60 along the Z-axis registering the movement of the focusing lens group 230. Thus the final focus relative to the nozzle tip can be tracked and recorded.

FIG. 3 also shows a gas delivery chamber 40 which provides means for the introduction of a gas stream that substantially surrounds the focused beam and is directed along the laser beam's axis. The coaxial gas jet nozzle 44 is centered around the focused beam and pressurized with oxygen and is directed at the workpiece with the focused laser beam. Oxygen is introduced through the gas jet aperture 42 to react with the workpiece being cut, heating the workpiece to a molten consistency to perform cutting very similar to oxyacetylene cutting. The focused laser beam acts as an ignition source and controls the reaction of the oxygen with the metal. In this manner, it is possible to cut the workpiece with a very fine kerf with precision.

What is claimed is:

1. A nozzle assembly, comprising:
laser beam means for cutting an outer surface of a workpiece relative to a nozzle tip;
means for focusing the laser beam relative to a height of the outer surface of the workpiece; and
means for controlling a depth of a final focus by rotary movement of a focusing lens group housing relative to the nozzle tip; said controlling means including a cylindrical dial coupled to the focusing lens group housing providing for simultaneous rotation of the dial and the focusing lens group housing along at least a rotary axis and engaging a focusing lens group contained within the focusing lens group housing to move along a Z-axis for the final focus relative to the nozzle tip.

2. The apparatus of claim 1 including means for measuring a rotational position of the dial.

3. The apparatus of claim 2 wherein the dial's cylindrical exterior surface is marked off in units of measurement.

4. The apparatus of claim 1 including means for tracking the rotational position of the focusing lens group; said tracking means including moving a knob of a height indicator assembled in a groove along the Z-axis in conjunction with the rotation of the dial to capture the final focus of the focusing lens group as measured by a micrometer.

5. The apparatus of claim 4 wherein the height indicator is marked off in units of measurement.

6. The apparatus of claim 1 including means for introducing a gas stream to substantially surround the focused laser beam to aid in the cutting of the workpiece.

7. The apparatus of claim 1 including means for securing the nozzle to a nozzle body.

8. The apparatus of claim 7 including means for securing the nozzle body to the dial enabling simultaneous movement of the nozzle body with the focusing lens group housing during the cutting of the workpiece.

9. The apparatus of claim 8 including means for rotating the focusing lens group housing about its own axis further reducing the final focus relative to the height of the workpiece.

10. The apparatus of claim 1 including means for changing the focus during the cutting of the workpiece to have a sufficiently reduced focus without moving the nozzle.

11. The apparatus of claim 1 said controlling means further including means for moving the focusing lens group contained within the focusing lens group housing; said moving means including spiral grooves in an interior wall of the dial cooperating with a pair of pins on the focusing lens group housing riding in the grooves guiding the focusing lens group upwards or downwards according to the rotating direction of the dial.

12. A method of focusing a laser beam, comprising the steps of:
directing the laser beam through an aperture which is continuous throughout a focusing lens group housing and a nozzle body tapering at a nozzle tip;
adjusting a focal distance between a focusing lens group relative to a height of an outer surface of a workpiece;
controlling a depth of a final focus by moving along at least a Y-axis the focusing lens group housing relative to the height of the outer surface of the workpiece; said controlling including simultaneously rotating a cylindrical dial and the focusing lens group housing that is coupled to the dial creating relative movement of the focusing lens group contained within the focusing lens group housing along a Z-axis thereby;
providing a closer approach of the focusing lens group to the nozzle tip effecting a reduction in a final focus; and
registering a rotational position for the final focus.

13. A method of claim 12 wherein said registering step includes recording the rotational position as indicated on the dial's demarcations.

14. A method of claim 12 wherein said registering step includes recording the rotational position as registered on a height indicator's micrometer.

15. The method of claim 12, further including injecting a gas jet stream into the nozzle body to substantially surround the laser beam along the laser beam's axis.

16. A method of claim 12 further including the steps of moving the focusing lens group by rotating the dial concurrently with the focusing lens group housing engaging a pair of pins on the focusing lens group housing riding in the groves of the spiral cut track on the interior wall of the dial thereby guiding the focusing lens group upwards or downwards according to the rotating direction of the dial.
